(19) United States
(12) Patent Application Publication
(10) Pub. No.: US 2009/0226703 A1
(43) Pub. Date: Sep. 10, 2009

(54) ADHESIVE BONDING ASSEMBLY AND METHOD FOR MAKING THE SAME

(75) Inventors: HAI-QUAN ZHENG, Shenzhen City (CN); JIAN-MING HUANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/248,592

(22) Filed: Oct. 9, 2008

(30) Foreign Application Priority Data
Mar. 5, 2008 (CN) 200810300474.2

(51) Int. Cl. B32B 3/26; B32B 37/12

(52) U.S. Cl. 428/320.2; 156/60

(57) ABSTRACT

An exemplary adhesive bonding assembly includes a first component, a second embodiment, and an adhesive substance. The first component includes a first bonding surface and an operation surface opposite to the first bonding surface. A channel is defined in the first component extending from the first bonding surface to the operation surface. The second component includes a second bonding surface contacting the first bonding surface. The adhesive substance is received in the channel for bonding the first component and the second component together. A method for making the adhesive bonding assembly is also provided.

### BACKGROUND

1. Technical Field

The present disclosure generally relates to an adhesive bonding assembly and a method for making the same.

2. Description of the Related Art

Generally, two components of an electronic device may be bonded to each other by means such as hot-pressure welding, cold-pressure welding, or rivet jointing. However, if the components are small or a nice appearance is required, the components may be bonded to each other by an adhesive bonding technique to form an adhesive bonding assembly.

Referring to FIG. 8, one such adhesive bonding assembly 100 includes a first component 101 having a first bonding surface 103 and a second component 105 having a second bonding surface 107 corresponding to the first bonding surface 103. The first bonding surface 103 and the second bonding surface 107 are both coated with an adhesive (not labeled). The first component 101 is bonded to the second component 105 by the adhesive. However, if the first component 101 is not precisely positioned to a predetermined area of the second bonding surface 107, the adhesives are removed from the first and second bonding surfaces 103, 107. After the adhesives are removed, the first and second bonding surfaces 103, 107 are coated with the adhesive again so that the first component 101 may be repositioned to the predetermined area of the second surface 107. If the first component 101 is not precisely positioned to the predetermined area of the second surface 107, it is troublesome to adjust the first component 101 and an efficiency of manufacturing the adhesive bonding assembly 100 is relatively low. In addition, if too much of the adhesive is coated on the first bonding surface 103 or the second bonding surface 107, the adhesive may overflow, resulting in an unattractive appearance of the adhesive bonding assembly. Therefore, the overflowing adhesive is removed from the adhesive bonding assembly further decreasing the efficiency of manufacturing the adhesive bonding assembly 100.

Therefore, a new adhesive bonding assembly and a method for making the same is desired to overcome the above-described shortcomings.

### SUMMARY

An adhesive bonding assembly includes a first component, a second embodiment, and an adhesive substance. The first component includes a first bonding surface and an operation surface opposite to the first bonding surface. A channel is defined in the first component extending from the first bonding surface to the operation surface. The second component includes a second bonding surface contacting the first bonding surface. The adhesive substance is received in the channel for bonding the first component and the second component together.

A method for making an adhesive bonding assembly, includes providing a first component including a first bonding surface and an operation surface opposite to the first bonding surface, a second component including a second bonding surface, and an adhesive substance for bonding the first component and the second component together, wherein a channel is defined in the first component extending from the first bonding surface to the operation surface; positioning the first component on the second component such that the first bonding surface contacts the second bonding surface of the second component, and injecting the adhesive substance into the channel of the first component such that the first component is bonded to the second component by the adhesive substance.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present adhesive bonding assembly. Moreover, in the drawings, like reference numerals designate corresponding parts throughout the several views, and all the views are schematic.

FIG. 1 is an isometric view of a first embodiment of an adhesive bonding assembly.

FIG. 2 is a top view of the adhesive bonding assembly shown in FIG. 1.

FIG. 3 is a cross-sectional view of the adhesive bonding assembly shown in FIG. 1, taken along line III-III thereof.

FIG. 4 is a top view of a second embodiment of the adhesive bonding assembly.

FIG. 5 is a cross-sectional view of the adhesive bonding assembly shown in FIG. 4, taken along line V-V thereof.

FIG. 6 is a top view of a third embodiment of the adhesive bonding assembly.

FIG. 7 is a cross-sectional view of the adhesive bonding assembly shown in FIG. 6, taken along line VII-VII thereof.

FIG. 8 is an isometric view of a typical adhesive bonding assembly.

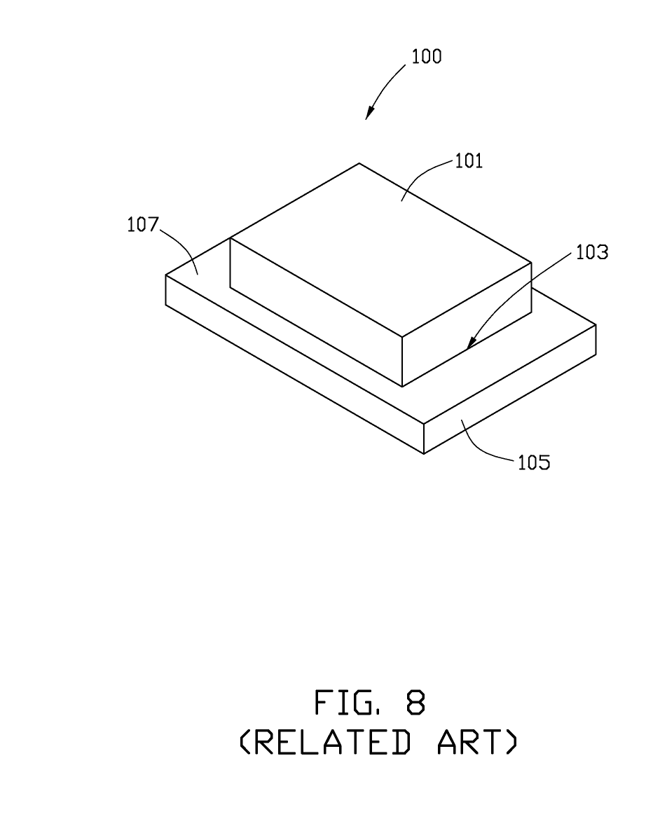

### DETAILED DESCRIPTION OF THE EMBODIMENTS

Reference will now be made to the drawings to describe various inventive embodiments of the present adhesive bonding assembly in detail.

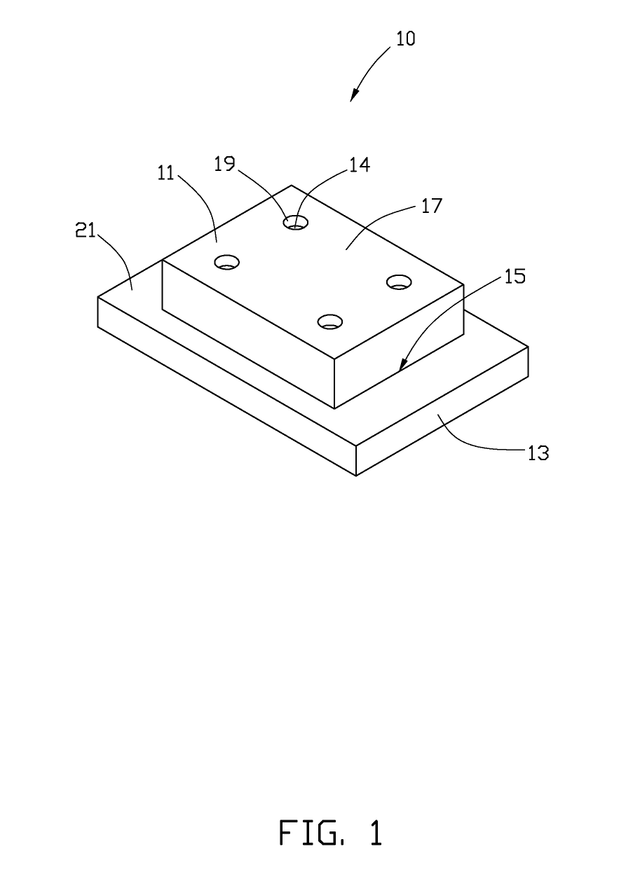

Referring to FIG. 1, a first embodiment of an adhesive bonding assembly 10 includes a first component 11, a second component 13, and an adhesive substance 14 for bonding the first component 11 and the second component 13 together tightly.

The first component 11 includes a first bonding surface 15 and an operation surface 17 opposite to the first bonding surface 15. The first component 11 defines a plurality of channels 19 extending from the first bonding surface 15 to the operation surface 17. In the first embodiment, the channels 19 are circular through holes. The second component 13 includes a second bonding surface 21 contacting the first bonding surface 15. The first bonding surface 15 is smaller than the second bonding surface 21.

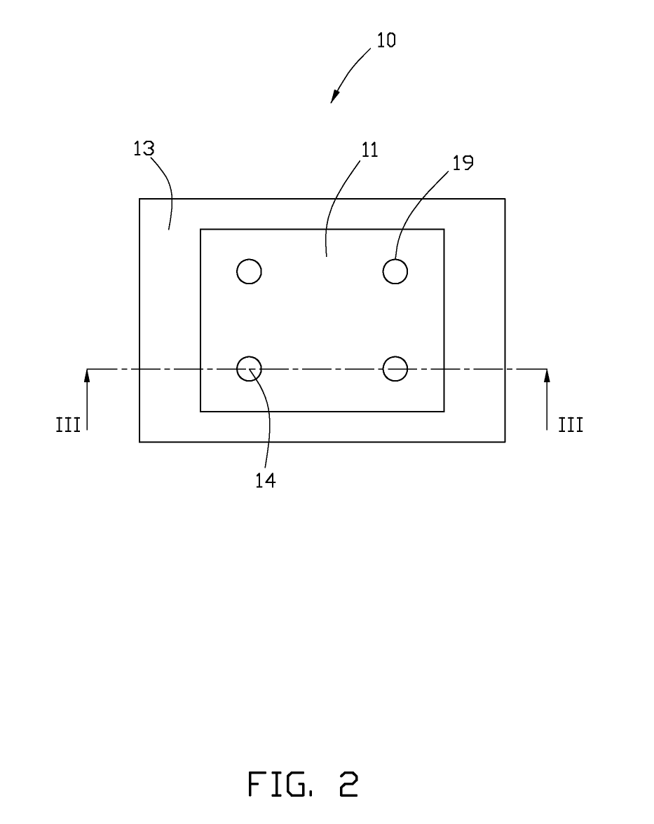

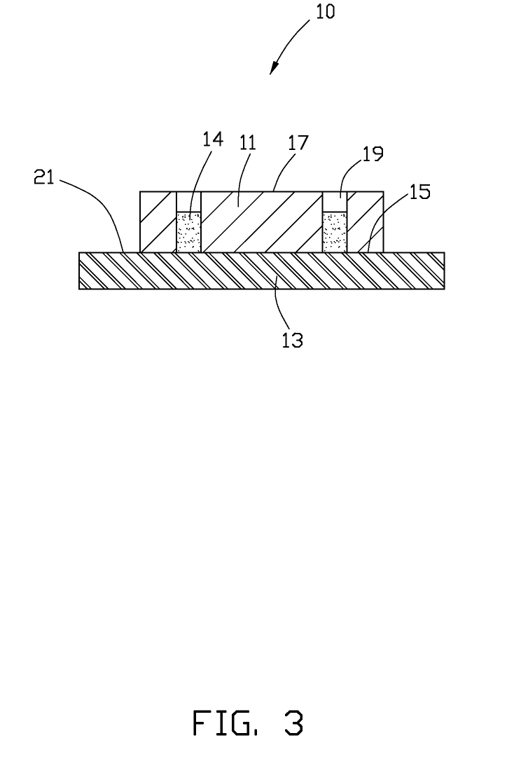

Referring to FIGS. 2 and 3, when the first bonding surface 15 abuts the second bonding surface 21, the adhesive substance 14 in a liquid state is injected into the channels 19 and the adhesive substance 14 flows into a portion of the second bonding surface 21. Thus, the first component 11 is bonded to the second component 13 by the adhesive substance 14. If too much of the adhesive substance 14 is injected, the excessive adhesive substance 14 is retained in the channels 19, thus preventing the excessive adhesive substance 14 from overflowing out of the first bonding surface 15.

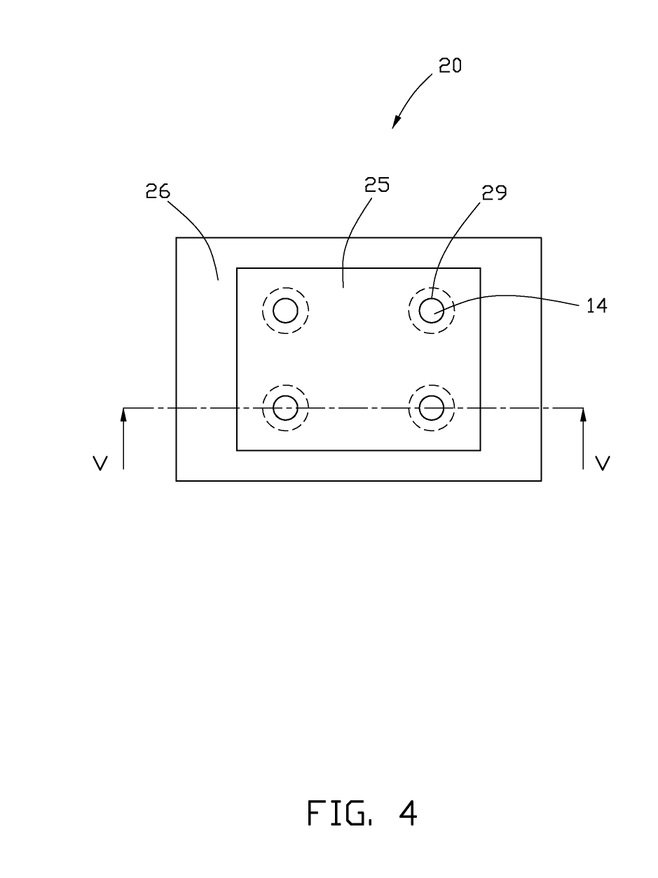

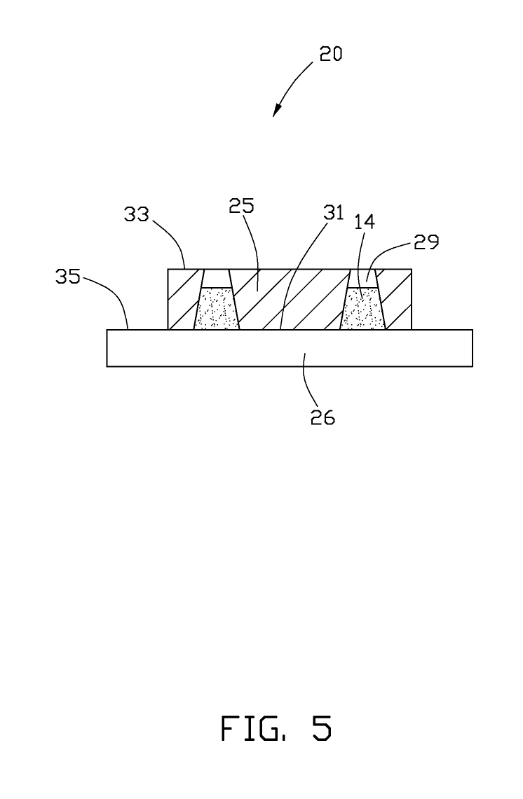

Referring to FIGS. 4 and 5 together, a second embodiment of an adhesive bonding assembly 20 is similar in principle to the first embodiment of the adhesive bonding assembly 10. The adhesive bonding assembly 20 includes a first component 25, a second component 26, and an adhesive substance 14 for bonding the first component 25 and the second component 26 together tightly. The first component 25 defines a plurality of channels 29 and includes a first bonding surface 31 and an operation surface 33 opposite to the first bonding surface 31. The channels 29 extend from the first bonding surface 31 to the operation surface 33. The second component 26 includes a second bonding surface 35 contacting the first bonding surface 31. However, in the second embodiment, the channels 29 are frustoconical-shaped through holes. A diameter of each channel 29 decreases from the first bonding surface 31 to the operation surface 33. Therefore, contact surfaces between the second bonding surface 35 and the adhesive substance 14 are increased thereby increasing the bonding area between the first and second component 25, 26.

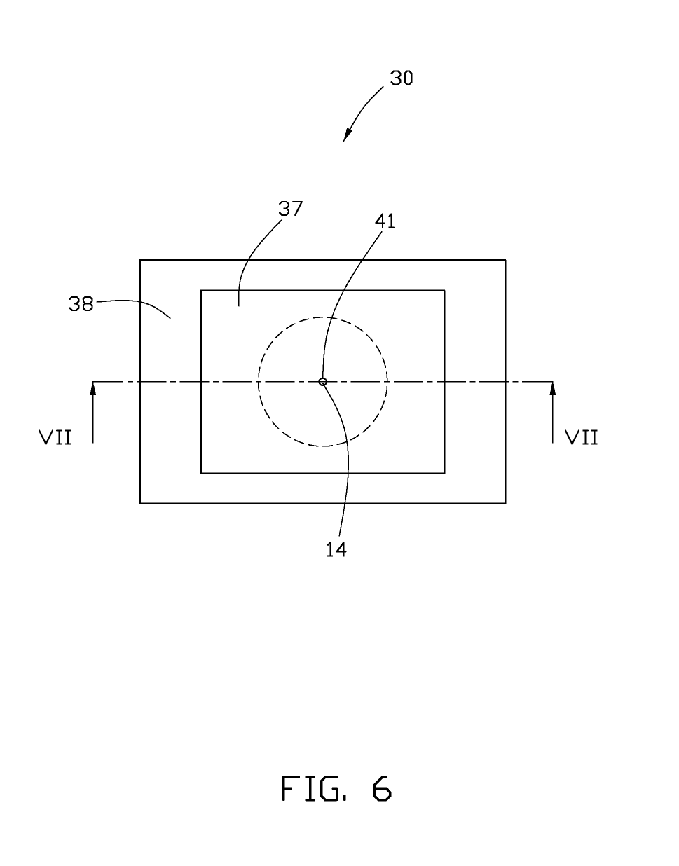

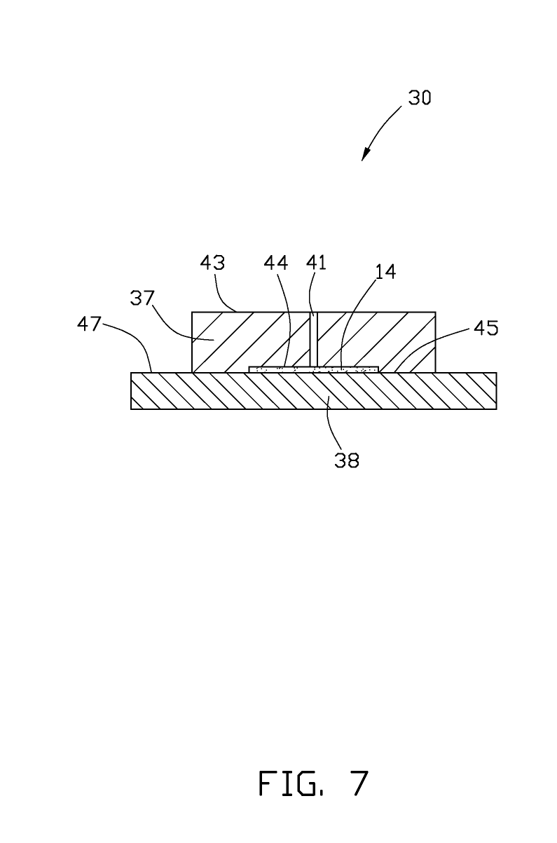

Referring to FIGS. 6 and 7, a third embodiment of an adhesive bonding assembly 30 includes a first component 37, a second component 38, and an adhesive substance 14 for bonding the first component 37 and the second component 38 together tightly. The first component 37 defines a channel 41 and includes an operation surface 43 and a first bonding surface 45 opposite to the operation surface 43. The channel 41 extends from the operation surface 43 to the first bonding surface 45. The second component 38 includes a second bonding surface 47 contacting the first bonding surface 45. In the third embodiment, the channel 41 is a through hole extending through to a cavity 44 defined in the first bonding surface 45. The cavity 44 does not extend past the first bonding surface 45. The cavity 44 allows the bonding area between the first and second component 37, 38 to be large. Therefore, a bonding strength between the first component 37 and the second component 38 is enhanced.

An embodiment of a method for making the above-described adhesive bonding assemblies 10, 20, 30 includes the steps described below. Depending on the embodiment, certain of the steps described below may be removed, others may be added, and the sequence of steps may be altered.

In a first step, a first component 11, 25, 37, a second component 13, 26, 38, and an adhesive substance 14 for bonding the first component 11 and the second component 13 together are provided. In a second step, the first component 11, 25, 37 is positioned on the second component 13, 26, 38 with the first bonding surface 15, 31, 45 abutting a predetermined area of the second bonding surface 21, 35, 47. In a third step, the adhesive substance 14 in a liquid state is injected into the channels 19, 29, 41. The adhesive substance 14 flows into a portion of the predetermined area of the second bonding surface 21. When the adhesive substance 14 in a liquid state solidifies, the first component 11 is bonded to the second component 13 by the adhesive substance 14.

In this method the first component 11 is positioned on the predetermined area on of the second bonding surface 21 of the second component 13 prior to injecting the adhesive substance 14 into the channels 19, so that the first component 11, 25, 37 may be positioned on the predetermined area of the second bonding surface 21, 35, 47. Therefore, an efficiency of making the adhesive bonding assembly 10 is greatly improved.

It may be appreciated that the channels 19, 29, 41 may be other shapes, such as rectangular holes and triangular holes.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. An adhesive bonding assembly comprising:
a first component comprising a first bonding surface and an operation surface opposite to the first bonding surface, wherein a channel is defined in the first component extending from the first bonding surface to the operation surface;
a second component comprising a second bonding surface contacting the first bonding surface; and
an adhesive substance received in the channel for bonding the first component and the second component together tightly.

2. The adhesive bonding assembly of claim 1, wherein the channel is a circular through hole.

3. The adhesive bonding assembly of claim 2, wherein the channel is a frustoconical-shaped through hole.

4. The adhesive bonding assembly of claim 3, wherein a diameter of the channel decreases from the operation surface to the first bonding surface.

5. The adhesive bonding assembly of claim 1, wherein a cavity is defined in the first bonding surface of the first component; the channel extends into the cavity.

6. The adhesive bonding assembly of claim 5, wherein the cavity does not extend past the first bonding surface.

7. A method for making an adhesive bonding assembly, the method comprising:
providing a first component comprising a first bonding surface and an operation surface opposite to the first bonding surface, a second component comprising a second bonding surface, and an adhesive substance for bonding the first component and the second component together, wherein a channel is defined in the first component extending from the first bonding surface to the operation surface;
positioning the first component on the second component such that the first bonding surface contacts the second bonding surface of the second component; and injecting the adhesive substance into the channel of the first component such that the first component is bonded to the second component by the adhesive substance.
